(19) United States
(12) Patent Application Publication
(10) Pub. No.: US 2025/0044723 A1
(43) Pub. Date: Feb. 6, 2025

(54) TONER COLLECTION DEVICE AND IMAGE FORMING APPARATUS

(71) Applicant: FUJIFILM Business Innovation Corp., Tokyo (JP)

(72) Inventors: Kazuki KISHI, Kanagawa (JP); Yutaka KIUCHI, Kanagawa (JP)

(73) Assignee: FUJIFILM Business Innovation Corp., Tokyo (JP)

(21) Appl. No.: 18/432,638

(22) Filed: Feb. 5, 2024

(30) Foreign Application Priority Data
Jul. 31, 2023 (JP) 2023-124568

(51) Int. Cl. G03G 15/08; G03G 21/12

(52) U.S. Cl. CPC G03G 15/0898; G03G 21/12

(57) ABSTRACT

A toner collection device includes a toner containing portion that is moved in one direction to be installed on a side of a main body and includes a discharge port that discharges toner in an intersecting direction that intersects with the one direction, a toner collection portion that is provided on the side of the main body and collects toner via a collection port opposed to the discharge port of the toner containing portion moved in the one direction, a seal member that is provided between the discharge port and the collection port and is compressed to increase a sealing property of a connection portion between the discharge port and the collection port and suppress scattering of the toner to outside, and a mechanism that increases a compression amount of the seal member along with movement of the toner containing portion in the one direction.

### CROSS-REFERENCE TO RELATED APPLICATIONS

This application is based on and claims priority under 35 USC 119 from Japanese Patent Application No. 2023-124568 filed Jul. 31, 2023.

### BACKGROUND

### (i) Technical Field

The present disclosure relates to a toner collection device and an image forming apparatus.

### (ii) Related Art

For example, Japanese Unexamined Patent Application Publication No. 2019-082642 describes the use of a shutter or a seal member at a toner discharge port provided in a developing device in order to provide a developing system that may suppress excessive discharge of waste toner from the developing device. Furthermore, Japanese Unexamined Patent Application Publication No. 2019-082642 describes that the developing device is inserted into a toner collection device in order to connect the developing device to the toner collection device.

### SUMMARY

Furthermore, consideration is given to, for example, a case where a toner containing portion of a developing device, or the like, is moved in one direction to be installed on the side of a main body. In this case, in order to discharge the toner contained in the toner containing portion to the side of the main body, the configuration is often such that a discharge port of the toner containing portion and a collection port on the side of the main body are provided to be connected when the toner containing portion is moved to be installed on the side of the main body. Furthermore, in a case of adopting this configuration, a seal member is typically provided between the discharge port and the collection port to suppress scattering of the toner.

However, in a case where the discharge port and the collection port are provided in a direction intersecting with the one direction in which the toner containing portion is moved, there is a possibility that a defect such as peeling of a seal member provided in the discharge port and/or the collection port may occur along with the movement of the toner containing portion in the one direction.

Aspects of non-limiting embodiments of the present disclosure relate to suppressing the occurrence of a defect of a seal member provided between a discharge port and a collection port of the toner when the toner containing portion is moved in one direction to be installed on the side of the main body.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a toner collection device including a toner containing portion that is moved in one direction to be installed on a side of a main body and includes a discharge port that discharges toner in an intersecting direction that intersects with the one direction, a toner collection portion that is provided on the side of the main body and collects toner via a collection port opposed to the discharge port of the toner containing portion moved in the one direction, a seal member that is provided between the discharge port and the collection port and is compressed to increase a sealing property of a connection portion between the discharge port and the collection port and suppress scattering of the toner to outside, and a mechanism that increases a compression amount of the seal member along with movement of the toner containing portion in the one direction.

### BRIEF DESCRIPTION OF THE DRAWINGS

An exemplary embodiment of the present disclosure will be described in detail based on the following figures, wherein:

FIG. 1 is a diagram illustrating an overall configuration of an image forming apparatus to which the present exemplary embodiment is applied;

FIG. 2 is a perspective view illustrating an overall configuration of a toner collection device;

FIG. 3 is a perspective view illustrating a positional relationship between a vertical movement mechanism and a toner collection portion in the toner collection device;

FIG. 4 is a diagram illustrating movement of toner from the toner collection device to the toner collection portion;

FIG. 5 is a diagram illustrating a joint structure between a discharge port and a collection port when a developing device is moved to be installed on a side of a main body; and

FIGS. 6A, 6B, and 6C are diagrams illustrating an operation of moving and installing the developing device on the side of the main body and an action until the discharge port is joined to the collection port by the operation.

### DETAILED DESCRIPTION

With reference to the accompanying drawings, the present exemplary embodiment will be described below in detail.

### [Description of Image Forming Apparatus]

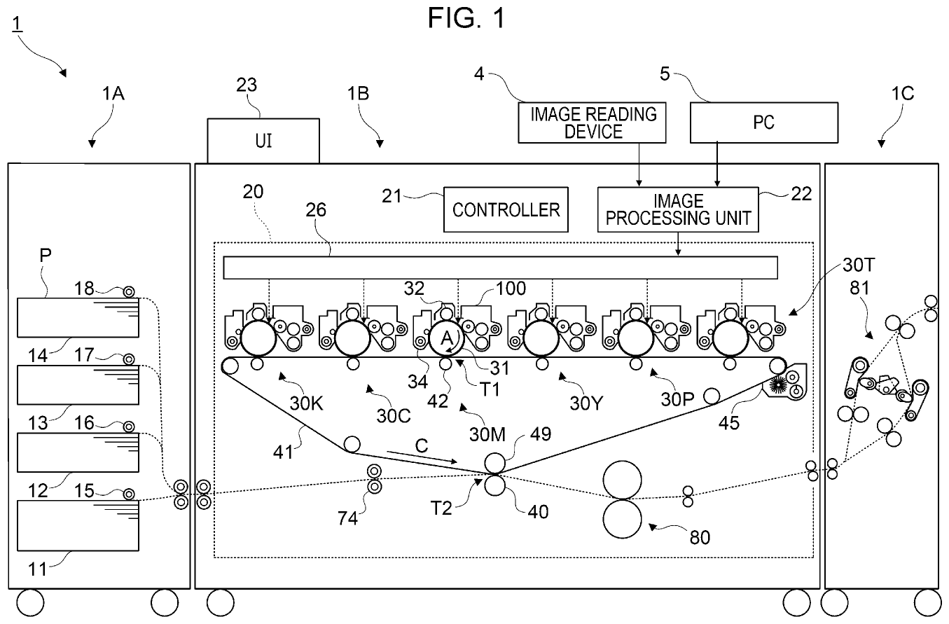

FIG. 1 is a diagram illustrating an image forming apparatus 1 to which the present exemplary embodiment is applied.

The image forming apparatus 1 according to the present exemplary embodiment includes a paper feed unit 1A, a printing unit 1B, and a paper ejection unit 1C.

The paper feed unit 1A includes a first paper containing portion 11 to a fourth paper containing portion 14 that contain paper P as an example of a recording medium.

Furthermore, the paper feed unit 1A includes feed rollers 15 to 18 that are provided corresponding to the first paper containing portion 11 to the fourth paper containing portion 14, respectively, and that feed the paper P contained in each paper containing portion to transport paths connected to the printing unit 1B.

The printing unit 1B includes an image forming portion 20 that forms an image on the paper P. Furthermore, the printing unit 1B includes a controller 21 that controls each unit of the image forming apparatus 1.

Further, the printing unit 1B includes an image processing unit 22. The image processing unit 22 performs image processing on image data transmitted from an image reading device 4 or a personal computer (PC) 5.

Moreover, the printing unit 1B includes a user interface (UI) 23 that includes a touch panel, or the like, notifies a user of information, and receives input of information from a user.

The image forming portion 20 includes six image forming units 30T, 30P, 30Y, 30M, 30C, and 30K (hereinafter may be simply referred to as “image forming units 30”) arranged in parallel at constant intervals.

Each of the image forming units 30 includes a photoconductor drum 31 on which an electrostatic latent image is formed while rotating in the direction of arrow A, a charging roller 32 that charges a surface of the photoconductor drum 31, a developing device 100 that develops the electrostatic latent image formed on the photoconductor drum 31, and a drum cleaner 34 that removes toner, and the like, from the surface of the photoconductor drum 31.

Furthermore, the image forming portion 20 includes a laser exposure device 26 that exposes the photoconductor drum 31 in each of the image forming units 30 with a laser beam.

Further, the exposure of the photoconductor drum 31 by the laser exposure device 26 is not limited to the use of a laser beam. For example, a light source such as a light emitting diode (LED) may be provided for each of the image forming units 30, and the light emitted from the light source may be used to expose the photoconductor drum 31.

Each of the image forming units 30 is configurated in the similar manner except for the toner stored in the developing device 100. The image forming units 30Y, 30M, 30C, and 30K form yellow (Y), magenta (M), cyan (C), and black (K) toner images, respectively.

Furthermore, the image forming units 30T and 30P form toner images by using the toner corresponding to a corporate color, a foaming toner for Braille, a fluorescent color toner, a toner for improving glossiness, or the like. In other words, the image forming units 30T and 30P form toner images by using special color toner.

Furthermore, the image forming portion 20 includes an intermediate transfer belt 41 to which the toner images in the respective colors formed on the photoconductor drums 31 of the respective image forming units 30 are transferred.

Further, the image forming portion 20 includes a first transfer roller 42 that transfers each color toner image of each of the image forming units 30 to the intermediate transfer belt 41 at a first transfer portion T1.

Further, the image forming portion 20 includes a second transfer roller 40 that collectively transfers the toner images transferred on the intermediate transfer belt 41 to the paper P at a second transfer portion T2.

Furthermore, the image forming portion 20 includes a belt cleaner 45 that removes toner and the like on the surface of the intermediate transfer belt 41 and a fixing device 80 that fixes the secondarily transferred image to the paper P.

The image forming portion 20 performs an image forming operation based on a control signal from the controller 21.

Specifically, in the image forming portion 20, the image processing unit 22 performs image processing on the image data input from the image reading device 4 or the PC 5, and the image data having undergone image processing is supplied to the laser exposure device 26.

Further, in the image forming unit 30M for magenta (M), for example, the surface of the photoconductor drum 31 is charged by the charging roller 32, and then the photoconductor drum 31 is irradiated with the laser light modulated with the image data obtained from the image processing unit 22 by the laser exposure device 26.

Accordingly, an electrostatic latent image is formed on the photoconductor drum 31.

The formed electrostatic latent image is developed by the developing device 100, and a magenta toner image is formed on the photoconductor drum 31.

Similarly, yellow, cyan, and black toner images are formed in the image forming units 30Y, 30C, and 30K, and special color toner images are formed in the image forming units 30T and 30P.

The toner images of the respective colors formed in the image forming units 30 are electrostatically transferred by the first transfer rollers 42 in sequence onto the intermediate transfer belt 41 rotating in the direction of arrow C in FIG. 1, and toner images superimposed on the intermediate transfer belt 41 are formed.

The superimposed toner images formed on the intermediate transfer belt 41 are transported to the second transfer portion T2 including the second transfer roller 40 and a backup roller 49 along with the movement of the intermediate transfer belt 41.

On the other hand, the paper P is, for example, picked up from the first paper containing portion 11 by the feed roller 15 and then transported to the position of a registration roller 74 via the transport path.

When the superimposed toner image is transported to the second transfer portion T2, the paper P is supplied from the registration roller 74 to the second transfer portion T2 in the synchronized timing.

Then, in the second transfer portion T2, the superimposed toner images are transferred onto the paper P collectively and electrostatically by the action of the transfer electric field formed between the second transfer roller 40 and the backup roller 49.

Then, the paper P on which the superimposed toner image has been electrostatically transferred is conveyed to the fixing device 80.

In the fixing device 80, the paper P on which the unfixed toner image is formed is pressed and heated so that fixing processing of the toner image onto the paper P is performed.

Then, the paper P on which the fixing processing has been performed is conveyed to a paper stacking portion (not illustrated) after passing through a curl correction portion 81 provided in the paper ejection unit 1C.

### [Description of Toner Collection Device]

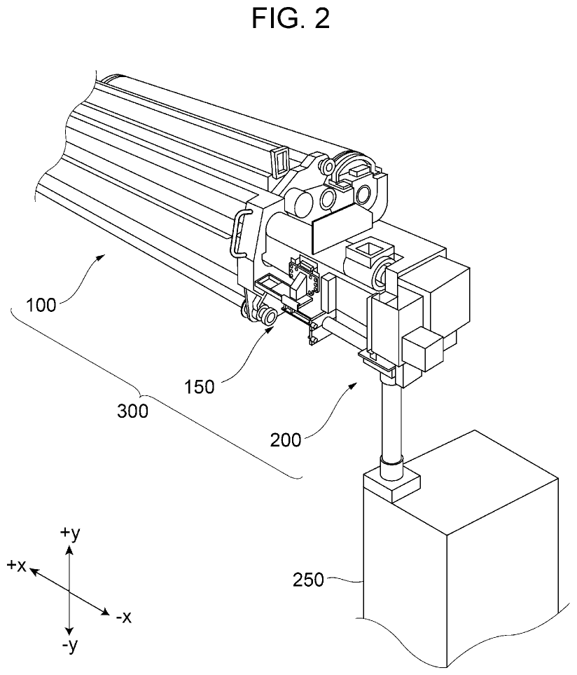

Next, a function of a toner collection device, which is a characteristic configuration of the present exemplary embodiment, will be described with reference to FIGS. 2 to 5.

FIG. 2 is a perspective view illustrating an overall configuration of the toner collection device and is a diagram of the developing device 100 when viewed from the back side (rear side) of the image forming apparatus 1 illustrated in FIG. 1. As illustrated in FIG. 2, a toner collection device 300 according to the present exemplary embodiment includes the developing device 100 that is moved in a +x direction from the near side (front side) to the back side (rear side) of the image forming apparatus 1 to be installed on the side of the main body and includes a toner collection portion 200 that is provided on the side of the main body that is the printing unit 1B. The +x direction is one direction according to the present exemplary embodiment. The toner collection portion 200 collects the toner via a collection port (described below) opposed to a discharge port (described below) of the developing device 100 moved in the one direction. The developing device 100 functions as an example of a toner containing portion and includes a vertical movement mechanism 150 that moves the discharge port (described below) in an upward direction (+y direction) and a downward direction (−y direction). Furthermore, the toner collection portion 200 includes a toner tank 250 that stores collected toner.

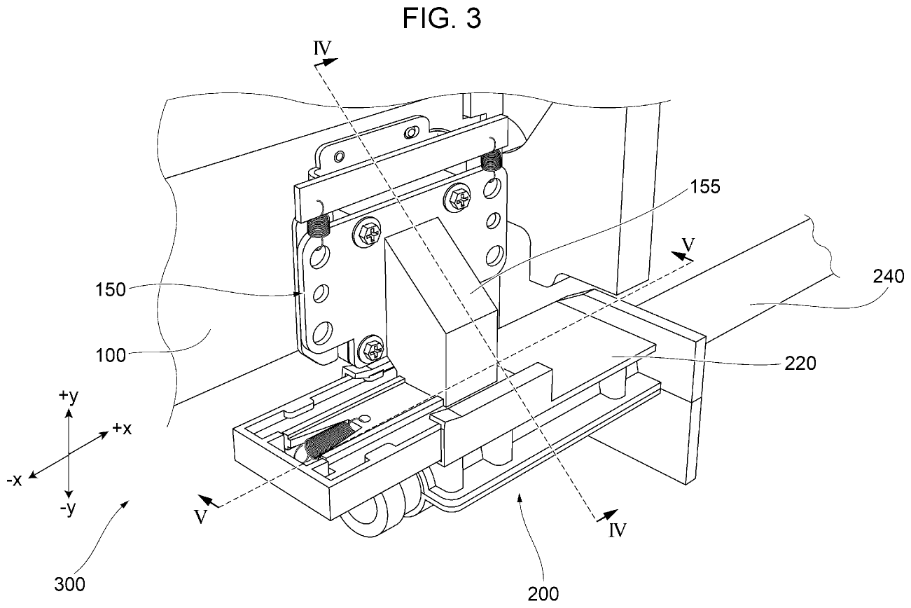

FIG. 3 is a perspective view that illustrates a positional relationship between the vertical movement mechanism 150 and the toner collection portion 200 in the toner collection device 300 and illustrates a state where the developing device 100 is installed on the side of the main body that is the printing unit 1B. The vertical movement mechanism 150 includes a discharge pipe 155 that feeds the toner in the downward direction (−y direction) toward the toner collection portion 200. The toner collection portion 200 includes a joint 220 that functions as one of the mechanisms that increase the compression amount of a seal member (described below) together with the vertical movement mechanism 150. Further, the toner collection portion 200 includes a pipe 240 that is a conveyance path of the collected toner.

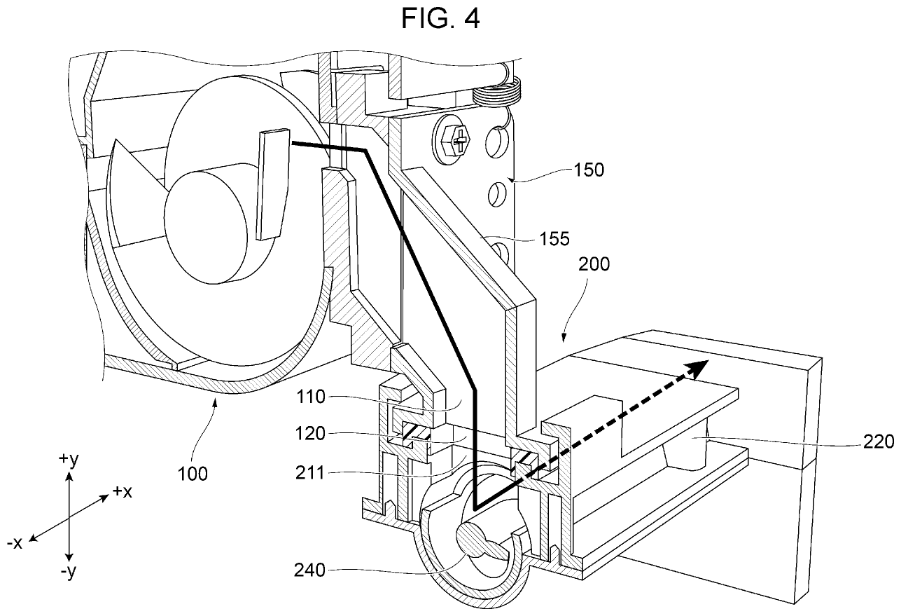

FIG. 4 is a diagram illustrating movement of the toner from the toner collection device 300 to the toner collection portion 200 and is an IV-IV cross-section in FIG. 3.

As illustrated in FIG. 4, the developing device 100, which is an example of the toner containing portion, includes a discharge port 110 below the discharge pipe 155 of the vertical movement mechanism 150. The discharge port 110 discharges the toner in an intersecting direction that intersects with the one direction (+x direction). Here, the one direction is a horizontal direction, and the intersecting direction that intersects with the one direction is a downward direction (−y direction) that is a vertical direction. However, the intersecting direction may be a diagonally downward direction at an angle with respect to the vertical direction (+y direction). The diagonally downward direction may be inclined at a predetermined angle from the vertical direction, for example, in the +x direction or the direction intersecting with the +x direction.

As illustrated in FIG. 4, the toner collection portion 200 includes a collection port 210 at the position opposed to the discharge port 110 of the developing device 100 when installed on the side of the main body. The discharge port 110 is positioned above the collection port 210 when the developing device 100, which the toner containing portion, is installed on the side of the main body. Furthermore, the discharge port 110 of the developing device 100 is provided with a seal member 120. An elastic material is used as the material of the seal member 120. For example, according to the present exemplary embodiment, the seal member 120 includes polyurethane. The seal member 120 is compressed between the discharge port 110 of the developing device 100 and the collection port 210 of the toner collection portion 200 to increase the sealing property of a connection portion between the discharge port 110 and the collection port 210 and suppress scattering of the toner to outside. For example, the thickness of the seal member 120 is, for example, approximately 4 mm before compression. This thickness is compressed to, for example, 1.5 to 2 mm between the discharge port 110 of the developing device 100 and the collection port 210 of the toner collection portion 200. This compression increases the sealing property of the connection portion between the discharge port 110 and the collection port 210. According to the present exemplary embodiment, one surface of the seal member 120 has a structure along a peripheral wall of the discharge port 110 and is provided to be overlapped with the peripheral wall of the discharge port 110. The structure along the peripheral wall has a shape in which a rectangular hole is cut out when the cross-sectional shape of the discharge pipe 155 parallel to the discharge port 110 is rectangular. The rectangular hole of the seal member 120 has the inner diameter dimension equivalent to the inner diameter dimension of the discharge port 110 and does not interfere with discharge of the toner from the discharge port 110. When the cross-sectional shape of the discharge pipe 155 is circular, the hole of the seal member 120 is also preferably circular to follow the cross-sectional shape of the discharge pipe 155. Furthermore, the position where the seal member 120 is provided is appropriate as long as the seal member 120 is provided between the discharge port 110 and the collection port 210 and, for example, the seal member 120 may be installed at the collection port 210. Further, for example, the seal member 120 may be provided at both the discharge port 110 and the collection port 210.

Furthermore, in FIG. 4, the thick line indicates the flow of the toner after the developing device 100, which is an example of the toner containing portion, is installed on the side of the main body. The toner from the developing device 100 is discharged from the discharge port 110 via the discharge pipe 155 and is collected in the collection port 210 of the toner collection portion 200. The collected toner is conveyed through the pipe 240 to the toner tank 250 illustrated in FIG. 2.

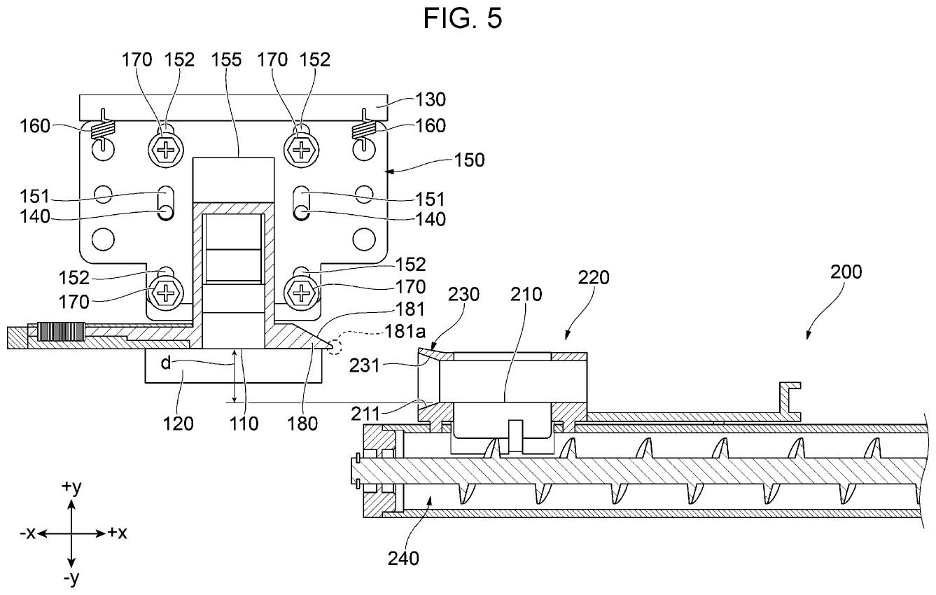

FIG. 5 is a diagram illustrating a joint structure between the discharge port 110 and the collection port 210 when the developing device 100 is moved to be installed on the side of the main body and is a V-V cross-section illustrated in FIG. 3.

The joint structure illustrated here is the joint structure between the discharge port 110 of the vertical movement mechanism 150 provided in the developing device 100, which is an example of the toner containing portion, and the collection port 210 of the toner collection portion 200 opposed to the vertical movement mechanism 150 when the developing device 100 is installed.

The vertical movement mechanism 150 includes a positioning elongated hole 151 that positions the vertical movement mechanism 150 with a positioning pin 140 protruding from the developing device 100 side and includes an elongated hole 152 with which the vertical movement mechanism 150 is attached to the developing device 100 side by using a shoulder screw 170. With the positioning elongated hole 151 and the elongated hole 152, the vertical movement mechanism 150 is allowed to move in the y direction within a predetermined range with respect to the developing device 100 while its movement in the x direction is restricted.

Furthermore, the joint structure includes an elastic member 160 having one end connected to a fixing component 130 on the developing device 100 side and the other end connected to the vertical movement mechanism 150. The elastic members 160 are provided at both ends of the vertical movement mechanism 150 in the x-axis direction. Then, the elastic force of the elastic member 160 applies a pull-up force in the ty direction to the vertical movement mechanism 150. That is, the discharge port 110 is moved upward (the +y direction) due to the elastic force of the elastic member 160. Furthermore, for example, a tension spring is used as the elastic member 160.

Further, as illustrated in FIG. 5, in the joint structure, the vertical movement mechanism 150 includes a sliding part 180. The sliding part 180 is a member extending in the moving direction of the developing device 100 and includes a slope 181 that is provided on the leading end side in the one direction (+x direction), which is the moving direction when the developing device 100 is installed on the side of the main body, and has a height gradually decreasing in the one direction. A lower end of the sliding part 180 extends in a horizontal direction, and the slope 181 is formed upward from the lower end in the horizontal direction. An extreme end 181a of the slope 181 extending from the lower end of the sliding part 180 is chamfered. As this chamfering, for example, round chamfering is performed.

Next, the joint 220 provided in the toner collection portion 200 configurating the joint structure includes a slide receiving portion 230 that receives the sliding part 180 of the developing device 100 moving in the one direction (+x direction). The slide receiving portion 230 includes a slope 231 opposed to the slope 181 of the sliding part 180. The slope 231 extends in the other direction (−x direction) that is a direction opposite to the one direction (+x direction) and inclines in the upward direction (+y direction) toward the other direction. When the developing device 100 moves in the one direction, the extreme end 181a of the slope 181 comes into contact with the slope 231 of the slide receiving portion 230. The contact position is maintained at the distance of the slope 231 within a range in which the extreme end 181a of the slope 181 is movable in the downward direction (−y direction) while being in contact with the slope 231. The slope 231 is configured such that the slope 181 of the sliding part 180 slides along with the movement of the developing device 100 in the one direction and the vertical movement mechanism 150 is movable in the downward direction (−y direction) via the slope 181. Specifically, the slope 181 of the sliding part 180 and the slope 231 of the slide receiving portion 230 are slopes facing each other and, by using the slopes facing each other, a distance d between the discharge port 110 and the collection port 210 in the intersecting direction, which intersects with the one direction, gradually becomes shorter than a distance during the movement of the developing device 100 in the one direction. That is, the distance between the collection port 210 and the discharge port 110 in the intersecting direction (the direction intersecting with the one direction) changes along with the movement of the developing device 100, which is a toner containing portion, in the one direction relative to the side of the main body. Furthermore, the seal member 120 attached to the discharge port 110 is configured to gradually contract as the distance between the discharge port 110 and the collection port 210 gradually becomes shorter.

Furthermore, the joint 220 includes an inclination 211. The inclination 211 is configured to receive the seal member 120 attached to the discharge port 110 of the developing device 100 moving in the one direction (+x direction). The inclination 211 is formed to extend in the other direction (−x direction) from the collection port 210 and is inclined in the downward direction (−y direction) toward the other direction (−x direction). When the developing device 100 moves in the one direction (+x direction), a lower corner of the leading end side of the seal member 120 in the one direction (+x direction) comes into contact with the inclination 211. Then, the leading end side in the one direction (+x direction) of the seal member 120 attached to the discharge port 110 is configured to be compressed while sliding on the surface of the inclination 211 and thus contract as compared with the original thickness of the seal member 120.

### [Action of Toner Collection Device]

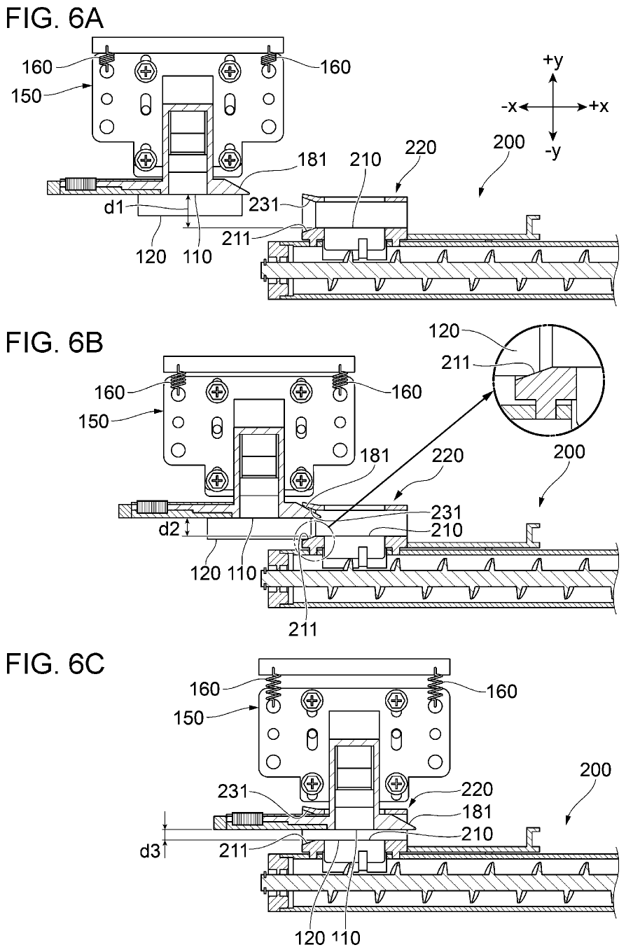

Next, an action of the present exemplary embodiment will be described with reference to FIGS. 6A to 6C. Here, an operation of moving and installing the developing device 100 on the side of the main body and an action until the discharge port 110 is joined to the collection port 210 by the operation will be described.

FIG. 6A illustrates a state before the developing device 100 is installed on the side of the main body and a state before the slope 181 of the sliding part 180 and the slope 231 of the slide receiving portion 230 come into contact with each other. In FIG. 6A, the vertical movement mechanism 150 is pulled up in the ty direction, which is the upward direction, due to the elastic force of the elastic member 160, and the discharge port 110 attached to the vertical movement mechanism 150 is positioned upward (+y direction). Furthermore, at this time, the thickness of the seal member 120 attached to the discharge port 110 is in an uncompressed state without any force applied thereto. Further, at this time, a distance d1 between the discharge port 110 and the collection port 210 in the intersecting direction, which intersects with the one direction, does not change.

FIG. 6B illustrates a state where the developing device 100 is moved in the one direction (+x direction) from the state of FIG. 6A and the slope 181 of the sliding part 180 and the slope 231 of the slide receiving portion 230 are in contact with each other. In FIG. 6B, along with the movement of the developing device 100 in the one direction (+x direction), the slope 181 of the sliding part 180 comes into contact with the slope 231 of the slide receiving portion 230, and with the subsequent movement of the developing device 100 in the one direction (+x direction), the slope 181 slides on the surface of the slope 231. The contact and slide between the slope 181 and the slope 231 have a relationship such that, when the slope 181 and the slope 231 are parallel to each other, they are in surface contact with each other and their surfaces slide on each other. However, in a case where the angles of the slope 181 and the slope 231 are not parallel to each other and are in a relation of intersecting with each other, the leading end of one of the slope 181 and the slope 231 is in a relation of contacting and sliding on a surface of the other.

As described above, the slope 181 and the slope 231 slide in contact with each other along with the movement of the developing device 100 in the one direction (+x direction), and thus the vertical movement mechanism 150 moves in the downward direction (−y direction) as compared with the state of FIG. 6A. That is, the vertical movement mechanism 150, which is pulled up in the ty direction by using the elastic force of the elastic member 160, is pushed down in the −y direction by the movement of the developing device 100 in the one direction (+x direction). Accordingly, the discharge port 110 positioned upward (+y direction) is pushed down in the −y direction with the movement of the developing device 100 in the one direction (+x direction). As a result, while the discharge port 110 and the collection port 210 have the distance d1 in the state of FIG. 6A, the discharge port 110 and the collection port 210 have the distance d2 shorter than the distance d1 in the state of FIG. 6B.

As the developing device 100 moves in the one direction (+x direction), the lower corner of the leading end side in the one direction (+x direction) of the seal member 120 attached to the discharge port 110 comes into contact with the inclination 211. Then, with further movement of the developing device 100 in the one direction (+x direction), the slope 181 and the slope 231 slide in contact with each other, and the vertical movement mechanism 150 further moves in the downward direction (−y direction). That is, the force against the elastic force of the vertical movement mechanism 150 is generated by the movement of the developing device 100 in the one direction (+x direction). By the downward movement of the vertical movement mechanism 150, the seal member 120 is gradually and largely compressed from the leading end side toward the rear end side while sliding on the surface of the inclination 211. Such a continuous increase in the compression amount of the seal member 120 suppresses a defect, such as peeling, of the leading end side of the seal member 120 during the compression.

FIG. 6C illustrates a state where the developing device 100 is further moved in the one direction (+x direction) from the state of FIG. 6B, the slope 181 of the sliding part 180 and the slope 231 of the slide receiving portion 230 end contact with each other, and the developing device 100 is installed on the side of the main body. In FIG. 6C, the discharge port 110 is further pushed down than in FIG. 6B, and the discharge port 110 and the collection port 210 are connected via the compressed seal member 120. A distance d3 between the discharge port 110 and the collection port 210 in the intersecting direction, which intersects with the one direction, when the developing device 100 is installed on the side of the main body is shorter than the distance d2 in FIG. 6B during the movement in the one direction, and thus the seal member 120 is also further compressed.

As described above, in the toner collection device 300 according to the present exemplary embodiment, the vertical movement mechanism 150 gradually moves downward along with the movement of the developing device 100 in the one direction, and the distance between the discharge port 110 and the collection port 210 gradually becomes shorter. Then, at that time, the seal member 120 is gradually compressed from the leading end side. As a result, when the seal member 120 attached to the discharge port 110 comes into contact with the surface on which the collection port 210 is formed, the seal member 120 is prevented from receiving a sudden impact on the leading end side thereof and is provided at an appropriate compression amount between the discharge port 110 and the collection port 210.

Furthermore, in the case where the seal member 120 is attached to the collection port 210 side, a configuration may be such that the inclination having the same action as the inclination 211 is provided below the sliding part 180 so that the leading end of the seal member 120 is gradually compressed.

Although the present exemplary embodiment has been described above, the present disclosure is not limited to the exemplary embodiment. For example, a translation cam structure or the like may be used so that the discharge port 110 is moved in the ty direction when the developing device 100 is moved in the one direction (+x direction) and is gradually lowered in the −y direction to compress the seal member 120 when the developing device 100 is installed.

### APPENDIX

(((1))

A toner collection device comprising:
a toner containing portion that is moved in one direction to be installed on a side of a main body and includes a discharge port that discharges toner in an intersecting direction that intersects with the one direction;
a toner collection portion that is provided on the side of the main body and collects toner via a collection port opposed to the discharge port of the toner containing portion moved in the one direction;
a seal member that is provided between the discharge port and the collection port and is compressed to increase a sealing property of a connection portion between the discharge port and the collection port and suppress scattering of the toner to outside; and
a mechanism that increases a compression amount of the seal member along with movement of the toner containing portion in the one direction.
   (((2)))

The toner collection device according to (((1))), wherein a distance between the collection port and the discharge port in the intersecting direction changes along with movement of the toner containing portion in the one direction relative to the side of the main body.

(((3)))

The toner collection device according to (((2))), wherein a distance between the collection port and the discharge port in the intersecting direction when the toner containing portion is installed on the side of the main body is shorter than a distance during the movement in the one direction.

(((4)))

The toner collection device according to (((3))), wherein the distance in the intersecting direction gradually becomes shorter than a distance during the movement in the one direction.

(((5)))

The toner collection device according to (((4))), wherein the toner containing portion and the toner collection portion or the side of the main body include slopes facing each other and, by using the slopes, the distance in the intersecting direction gradually becomes shorter than the distance during the movement in the one direction.

(((6)))

The toner collection device according to (((1))), wherein
the discharge port is positioned above the collection port when the toner containing portion is installed on the side of the main body,
the toner containing portion includes a vertical movement mechanism that vertically moves the discharge port, and
the discharge port is positioned upward by the vertical movement mechanism when the toner containing portion moves in the one direction, and the discharge port is pushed down to increase the compression amount of the seal member when the toner containing portion is installed on the side of the main body.
   (((7)))

The toner collection device according to (((6))), wherein the vertical movement mechanism moves the discharge port upward with respect to the toner containing portion due to an elastic force of an elastic member.

(((8)))

The toner collection device according to (((7))), wherein the mechanism that increases the compression amount generates a force against the elastic force of the vertical movement mechanism by the movement of the toner containing portion in the one direction.

(((9)))

An image forming apparatus comprising:
a main body including an image forming portion;
a developing device that forms part of the image forming portion, is moved in one direction to be installed on a side of the main body, develops an electrostatic latent image, and includes a discharge port that discharges toner in an intersecting direction that intersects with the one direction;
a toner collection portion that is provided on the side of the main body and collects toner discharged from the developing device via a collection port opposed to the discharge port of the developing device moved in the one direction;
a seal member that is provided between the discharge port and the collection port and is compressed to increase a sealing property of a connection portion between the discharge port and the collection port and suppress scattering of toner to outside; and
a mechanism that increases a compression amount of the seal member along with movement of the developing device in the one direction.

What is claimed is:

1. A toner collection device comprising:
a toner containing portion that is moved in one direction to be installed on a side of a main body and includes a discharge port that discharges toner in an intersecting direction that intersects with the one direction;
a toner collection portion that is provided on the side of the main body and collects toner via a collection port opposed to the discharge port of the toner containing portion moved in the one direction;
a seal member that is provided between the discharge port and the collection port and is compressed to increase a sealing property of a connection portion between the discharge port and the collection port and suppress scattering of the toner to outside; and
a mechanism that increases a compression amount of the seal member along with movement of the toner containing portion in the one direction.

2. The toner collection device according to claim 1, wherein a distance between the collection port and the discharge port in the intersecting direction changes along with movement of the toner containing portion in the one direction relative to the side of the main body.

3. The toner collection device according to claim 2, wherein a distance between the collection port and the discharge port in the intersecting direction when the toner containing portion is installed on the side of the main body is shorter than a distance during the movement in the one direction.

4. The toner collection device according to claim 3, wherein the distance in the intersecting direction gradually becomes shorter than a distance during the movement in the one direction.

5. The toner collection device according to claim 4, wherein the toner containing portion and the toner collection portion or the side of the main body include slopes facing each other and, by using the slopes, the distance in the intersecting direction gradually becomes shorter than the distance during the movement in the one direction.

6. The toner collection device according to claim 1, wherein
the discharge port is positioned above the collection port when the toner containing portion is installed on the side of the main body,
the toner containing portion includes a vertical movement mechanism that vertically moves the discharge port, and
the discharge port is positioned upward by the vertical movement mechanism when the toner containing portion moves in the one direction, and the discharge port is pushed down to increase the compression amount of the seal member when the toner containing portion is installed on the side of the main body.

7. The toner collection device according to claim 6, wherein the vertical movement mechanism moves the discharge port upward with respect to the toner containing portion due to an elastic force of an elastic member.

8. The toner collection device according to claim 7, wherein the mechanism that increases the compression amount generates a force against the elastic force of the vertical movement mechanism by the movement of the toner containing portion in the one direction.

9. An image forming apparatus comprising:
a main body including an image forming portion;
a developing device that forms part of the image forming portion, is moved in one direction to be installed on a side of the main body, develops an electrostatic latent image, and includes a discharge port that discharges toner in an intersecting direction that intersects with the one direction;
a toner collection portion that is provided on the side of the main body and collects toner discharged from the developing device via a collection port opposed to the discharge port of the developing device moved in the one direction;
a seal member that is provided between the discharge port and the collection port and is compressed to increase a sealing property of a connection portion between the discharge port and the collection port and suppress scattering of toner to outside; and
a mechanism that increases a compression amount of the seal member along with movement of the developing device in the one direction.
